(19) United States
(12) Patent Application Publication
(10) Pub. No.: US 2025/0149017 A1
(43) Pub. Date: May 8, 2025

(54) ULTRASONIC GENERATOR

(71) Applicants: NITTERRA CO., LTD., Nagoya-shi, Aichi (JP); THE UNIVERSITY OF TOKYO, Tokyo (JP)

(72) Inventors: Shinsuke ITOH, Nagoya-shi, Aichi (JP); Kota YOKOYAMA, Nagoya-shi, Aichi (JP); Satoshi SUZUKI, Nagoya-shi, Aichi (JP); Ryo SUZUKI, Nagoya-shi, Aichi (JP); Takashi KASASHIMA, Nagoya-shi, Aichi (JP); Takeshi MORITA, Tokyo (JP); Masatoshi TSUCHIDA, Tokyo (JP)

(73) Assignees: NITTERRA CO., LTD., Nagoya-shi, Aichi (JP); THE UNIVERSITY OF TOKYO, Tokyo (JP)

(21) Appl. No.: 18/837,380

(22) PCT Filed: Oct. 16, 2023
(86) PCT No.: PCT/JP2023/037356

§ 371 Date: Aug. 9, 2024

(30) Foreign Application Priority Data
Oct. 28, 2022 (JP) 2022-172906
Feb. 28, 2023 (JP) 2023-029224

(51) Int. Cl. G10K 11/28

(52) U.S. Cl. CPC G10K 11/28

(57) ABSTRACT

An ultrasonic generator (10) includes an ultrasonic wave generation source (11), an ultrasonic wave converging portion (12), and a waveguide (13). The waveguide (13) includes a first shaft portion (21), a second shaft portion (22), and a jutting out portion (30). The first shaft portion (21) extends from the ultrasonic wave converging portion (12) to one side in a predetermined direction. The second shaft portion (22) is disposed on the one side in the predetermined direction relative to the first shaft portion (21) and extends in the predetermined direction. The jutting out portion (30) is provided between the first shaft portion (21) and the second shaft portion (22) in the predetermined direction. The jutting out portion (30) juts out more outward than the outer circumferential surfaces of the first shaft portion (21) and the second shaft portion (22) in a plane direction orthogonal to the predetermined direction.

### TECHNICAL FIELD

The present invention relates to an ultrasonic generator.

### BACKGROUND ART

PTL 1 discloses an ultrasonic irradiator. The ultrasonic irradiator includes an ultrasonic vibrator and an acoustic propagating member that propagates the ultrasonic wave from the ultrasonic vibrator. The acoustic propagating member includes a main body and a shaft member extending forward from the front surface of the main body. The front surface of the main body functions as a concave primary reflecting surface that reflects the ultrasonic wave from the ultrasonic vibrator. The main body has a concave secondary reflecting surface that reflects the ultrasonic wave from the primary reflecting surface. The ultrasonic wave reflected by the secondary reflecting surface is propagated to the shaft member. Thus, an ultrasonic wave converged while being less attenuated is propagated to a waveguide constituted by the shaft member.

### CITATION LIST

### Patent Literature

PTL 1: Japanese Patent No. 6774697

### SUMMARY OF INVENTION

### Technical Problem

In the technique in PTL 1, there is concern that, when the outer circumferential surface of the waveguide comes into contact with an external object, the ultrasonic wave propagating through the waveguide leaks to the external object.

It is an objective of the present invention to provide a technique that can reduce a leakage of an ultrasonic wave propagating through a waveguide to the outside.

### Solution to Problem

[1] An ultrasonic generator of a first invention includes an ultrasonic wave generation source that generates an ultrasonic wave, an ultrasonic wave converging portion that converges the ultrasonic wave generated from the ultrasonic wave generation source, and a waveguide that transmits the ultrasonic wave converged by the ultrasonic wave converging portion. The ultrasonic wave converging portion includes a first reflecting surface and a second reflecting surface. The first reflecting surface reflects the ultrasonic wave generated at the ultrasonic wave generation source. The second reflecting surface reflects the ultrasonic wave reflected by the first reflecting surface. The first reflecting surface and the second reflecting surface are arranged such that the ultrasonic wave reflected by the second reflecting surface as a plane wave is introduced into the waveguide. The waveguide includes a first shaft portion, a second shaft portion, and a jutting out portion. The first shaft portion extends from the ultrasonic wave converging portion to one side in a predetermined direction. The second shaft portion is disposed on the one side in the predetermined direction relative to the first shaft portion and extends in the predetermined direction. The jutting out portion is provided between the first shaft portion and the second shaft portion in the predetermined direction. The jutting out portion juts out more outward than outer circumferential surfaces of the first shaft portion and the second shaft portion in a plane direction orthogonal to the predetermined direction.

According to the configuration, the ultrasonic wave generated from the ultrasonic wave generation source can be converged while being less attenuated and can be introduced into the waveguide as a plane wave. Moreover, since the waveguide includes the jutting out portion, an external object comes into contact with the jutting out portion, thereby being less likely to come into contact with the first shaft portion and the second shaft portion. That is, the region where the waveguide comes into contact with the external object is limited to a part of the waveguide. Thus, according to the configuration, it is possible to reduce a leakage of the ultrasonic wave propagating through the waveguide to the outside.

[2] In the ultrasonic generator according to the item [1], the waveguide may include a covering portion covering at least a part of the outer circumferential surfaces of the first shaft portion and the second shaft portion with a clearance interposed between the covering portion and the part of the outer circumferential surfaces of the first shaft portion and the second shaft portion, and the covering portion may be held on the jutting out portion.

According to the configuration, even when an external object comes into contact with the covering portion, there is likely to be a clearance between the external object and at least one of the first shaft portion and the second shaft portion. Thus, even when the external object comes into contact with the covering portion, it is possible to reduce a leakage of the ultrasonic wave propagating through the first shaft portion and the second shaft portion to the outside.

[3] In the ultrasonic generator according to the item [1] or [2], the waveguide may include a covering portion covering at least a part of an outer circumferential surface of the jutting out portion and having a cylindrical shape, and the covering portion may be held on the outer circumferential surface of the jutting out portion with a part of the covering portion in a circumferential direction being in contact with the outer circumferential surface of the jutting out portion.

According to the configuration, it is possible to reduce a leakage of the ultrasonic wave from the jutting out portion to the covering portion. Thus, even when an external object comes into contact with the covering portion, it is possible to reduce a leakage of the ultrasonic wave propagating through the waveguide to the external object through the covering portion.

[4] In the ultrasonic generator according to any one of the items [1] to [3], the jutting out portion may be formed such that an installation portion that is a different member from a waveguide main body constituting the first shaft portion and the second shaft portion is held on an outer circumferential surface of the waveguide main body.

According to the configuration, the jutting out portion and the waveguide main body can be made different in material.

[5] In the ultrasonic generator according to the item [4], the installation portion may include an extension portion covering a part of the outer circumferential surface of the waveguide main body with a clearance interposed between the extension portion and the outer circumferential surface of the waveguide main body.

According to the configuration, when an external object comes into contact with the extension portion, there is a clearance between the external object and the outer circumferential surface of the waveguide main body. Thus, even when the external object comes into contact with the extension portion, it is possible to reduce a leakage of the ultrasonic wave propagating through the waveguide main body to the outside.

[6] In the ultrasonic generator according to the item [4] or [5], the installation portion may be in contact with a part of the outer circumferential surface of the waveguide main body in a circumferential direction.

According to the configuration, it is possible to reduce a leakage of the ultrasonic wave from the waveguide main body to the installation portion. Thus, even when an external object comes into contact with the jutting out portion including the installation portion, it is possible to reduce a leakage of the ultrasonic wave propagating through the waveguide main body to the external object through the jutting out portion.

[7] In the ultrasonic generator according to any one of the items [1] to [3], the first shaft portion, the second shaft portion, and the jutting out portion may be formed as one member.

According to the configuration, the number of parts constituting the waveguide can be reduced.

[8] An ultrasonic generator of a second invention includes an ultrasonic wave generation source that generates an ultrasonic wave, an ultrasonic wave converging portion that converges the ultrasonic wave generated from the ultrasonic wave generation source, and a waveguide that transmits the ultrasonic wave converged by the ultrasonic wave converging portion. The ultrasonic wave converging portion includes a first reflecting surface and a second reflecting surface. The first reflecting surface reflects the ultrasonic wave generated at the ultrasonic wave generation source. The second reflecting surface reflects the ultrasonic wave reflected by the first reflecting surface. The first reflecting surface and the second reflecting surface are arranged such that the ultrasonic wave reflected by the second reflecting surface as a plane wave is introduced into the waveguide. The waveguide includes a shaft portion extending from the ultrasonic wave converging portion to one side in a predetermined direction. The ultrasonic generator further includes a cover covering an outer circumference of the shaft portion.

According to the configuration, the ultrasonic wave generated from the ultrasonic wave generation source can be converged while being less attenuated, and can be introduced into the waveguide as a plane wave. Moreover, the above-described ultrasonic generator includes the cover covering the outer circumference of the shaft portion. Thus, it is possible to prevent from the shaft portion from coming into direct contact with an external object, which makes the ultrasonic wave less likely to leak from the shaft portion. Thus, according to the configuration, it is possible to reduce a leakage of the ultrasonic wave propagating through the waveguide to the outside.

[9] In the ultrasonic generator according to the item [8], the cover is disposed around the shaft portion with a clearance interposed between the cover and the shaft portion. According to the configuration, even when an external object comes into contact with the cover, the ultrasonic wave propagating through the shaft portion is less likely to leak to the external object. Thus, according to the configuration, it is possible to reduce a leakage of the ultrasonic wave propagating through the waveguide to the outside.
[10] In the ultrasonic generator according to the item [8] or [9], the cover includes a first cover covering the outer circumference of the shaft portion and a second cover covering an outer circumference of the first cover. A value of an acoustic impedance of the first cover is more than or less than both values of an acoustic impedance of the shaft portion and an acoustic impedance of the second cover.

According to the configuration, the ultrasonic wave generated from the ultrasonic wave generation source can be converged while being less attenuated, and can be introduced into the waveguide as a plane wave. Moreover, since the first cover is disposed between the shaft portion of the waveguide and the second cover, an ultrasonic wave is made less likely to propagate between the shaft portion and the second cover. Thus, even when an external object comes into contact with the second cover, it is possible to reduce a leakage of the ultrasonic wave propagating through the shaft portion to the external object through the second cover. Thus, according to the configuration, it is possible to reduce a leakage of the ultrasonic wave propagating through the waveguide to the outside.

[11] In the ultrasonic generator according to the item [8], the cover is in contact with the shaft portion, and a wave propagation velocity in the shaft portion is slower than a wave propagation velocity in the cover.

According to the configuration, since the propagation of ultrasonic waves can be concentrated in the shaft portion, energy leakage from the side surface of the waveguide can be reduced. Thus, it is possible to reduce a leakage of the ultrasonic wave propagating through the waveguide to the outside.

[12] In the ultrasonic generator according to the item [11], the wave propagation velocity in the cover is preferably in a range of 1.3 to 1.7 times the wave propagation velocity in the shaft portion.

According to the configuration, the propagation of ultrasonic waves can be further concentrated in the shaft portion.

### Advantageous Effects of Invention

According to the present invention, it is possible to reduce a leakage of the ultrasonic wave propagating through the waveguide to the outside.

### BRIEF DESCRIPTION OF DRAWINGS

FIG. 1 is a side sectional view of an ultrasonic generator according to a first embodiment.

FIG. 2 is a sectional view taken along line A-A in FIG. 1.

FIG. 3 is a side sectional view of an ultrasonic generator according to a second embodiment.

FIG. 4 is a sectional view taken along line B-B in FIG. 3.

FIG. 5 is a sectional view taken along line C-C in FIG. 3.

FIG. 6 is a side sectional view of an ultrasonic generator according to a third embodiment.

FIG. 7 is a front view of a waveguide according to the third embodiment.

FIG. 8 is a side sectional view of an ultrasonic generator according to a fourth embodiment.

FIG. 9 is a sectional view taken along line D-D in FIG. 8.

FIG. 10 is a side sectional view of an ultrasonic generator according to a fifth embodiment.

FIG. 11 is a side sectional view of an ultrasonic generator according to a sixth embodiment.

FIG. 12 is a sectional view taken along line E-E in FIG. 11.

FIG. 13 is a side sectional view of a waveguide according to a first other embodiment.

FIG. 14 illustrates a waveguide according to a second other embodiment and is equivalent to FIG. 2.

FIG. 15 is a side sectional view of a waveguide according to a third other embodiment.

FIG. 16 illustrates a waveguide according to a fourth other embodiment and is equivalent to FIG. 4.

FIG. 17 illustrates a waveguide according to a fifth other embodiment and is equivalent to FIG. 4.

FIG. 18 illustrates a waveguide according to a sixth other embodiment and is equivalent to FIG. 4.

FIG. 19 illustrates a waveguide according to a seventh other embodiment and is equivalent to FIG. 4.

FIG. 20 is a side sectional view of an ultrasonic generator according to a seventh embodiment.

### DESCRIPTION OF EMBODIMENTS

### 1. First Embodiment

### 1-1. Configuration of Ultrasonic Generator 10

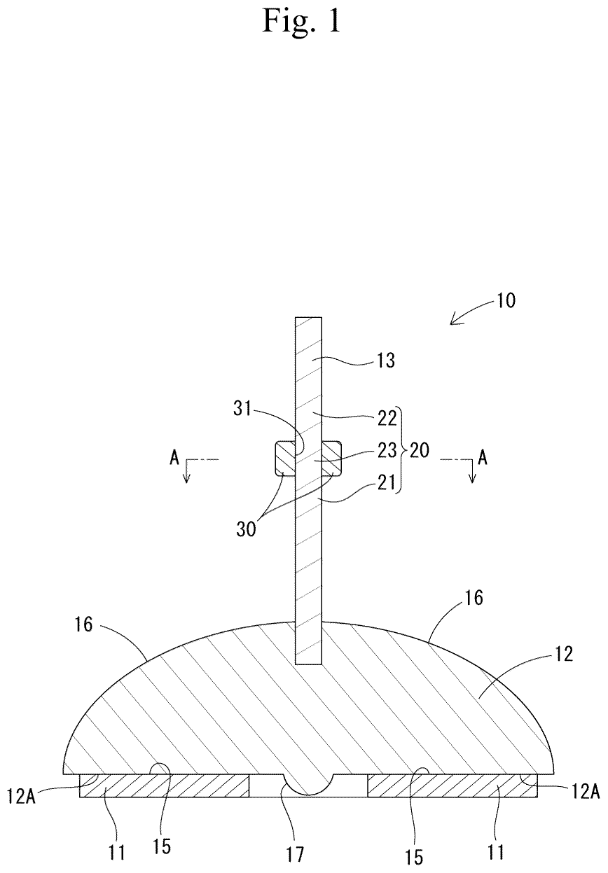

As illustrated in FIG. 1, an ultrasonic generator 10 includes an ultrasonic wave generation source 11, an ultrasonic wave converging portion 12, and a waveguide 13. The ultrasonic wave generation source 11 generates an ultrasonic wave. The ultrasonic wave converging portion 12 converges the ultrasonic wave generated from the ultrasonic wave generation source 11. The waveguide 13 transmits the ultrasonic wave converged by the ultrasonic wave converging portion 12. In the ultrasonic generator 10, the ultrasonic wave generation source 11, the ultrasonic wave converging portion 12, and the waveguide 13 are disposed in this order from the rear end side.

The ultrasonic wave generation source 11 is, for example, a piezo-electric element made of piezoelectric ceramics. The ultrasonic wave generation source 11 has a plate shape thick in a front-rear direction. The ultrasonic wave generation source 11 has an annular shape, specifically, a circular annular shape.

The ultrasonic wave generation source 11 generates an ultrasonic wave when receiving an electrical signal from a signal transmitting and receiving circuit, which is not illustrated. The ultrasonic wave generation source 11 has a radiating surface 15 which generates an ultrasonic wave. The radiating surface 15 is formed on the front surface of the ultrasonic wave generation source 11 and disposed while facing forward. The radiating surface 15 is a flat surface and extends in a direction orthogonal to the front-rear direction of the ultrasonic generator 10. The ultrasonic wave generated from the ultrasonic wave generation source 11 is a plane wave traveling forward in a straight line. The ultrasonic wave generation source 11 generates ultrasonic waves at frequencies of 30 kHz or higher and 3 MHz or lower, for example.

The ultrasonic wave converging portion 12 is formed of a metal (such as duralumin). The ultrasonic wave converging portion 12 has a circular shape when viewed in the front-rear direction. The ultrasonic wave converging portion 12 has a flat surface 12A on which the ultrasonic wave generated from the ultrasonic wave generation source 11 is incident. The flat surface 12A is formed on the rear surface of the ultrasonic wave converging portion 12 and disposed while facing rearward. The flat surface 12A has an annular shape, more specifically, a circular annular shape. The flat surface 12A is joined to the radiating surface 15 of the ultrasonic wave generation source 11.

The ultrasonic wave converging portion 12 has a first reflecting surface 16 and a second reflecting surface 17. The first reflecting surface 16 is disposed so as to face the radiating surface 15 of the ultrasonic wave generation source 11. A facing direction in which the first reflecting surface 16 and the radiating surface 15 of the ultrasonic wave generation source 11 face each other is parallel to the front-rear direction. When viewed from the outside of the ultrasonic wave converging portion 12, The first reflecting surface 16 is a curved surface (such as a paraboloid) that is convex to the front side (the side opposite to the ultrasonic wave generation source 11). When viewed from the inside of the ultrasonic wave converging portion 12, the first reflecting surface 16 is concave. The first reflecting surface 16 has an annular shape. The inner circumferential edge of the first reflecting surface 16 is positioned more forward than the outer circumferential edge of the first reflecting surface 16. The first reflecting surface 16 is a curved surface of revolution, specifically, a paraboloid of revolution, that is formed with the axial line extending through the center of the ultrasonic wave generation source 11 in the front-rear direction as the axis of rotation.

The second reflecting surface 17 is disposed so as to face the first reflecting surface 16. When viewed from the outside of the ultrasonic wave converging portion 12, the second reflecting surface 17 is a curved surface (such as a paraboloid) that is convex to the rear side (the side opposite to the first reflecting surface 16). When viewed from the inside of the ultrasonic wave converging portion 12, the second reflecting surface 17 is concave. The second reflecting surface 17 projects rearward. The second reflecting surface 17 projects more rearward than the flat surface 12A. The position of the front end of the second reflecting surface 17 in the front-rear direction is the same as the position of the flat surface 12A in the front-rear direction. The second reflecting surface 17 is disposed in an inner space of the ultrasonic wave generation source 11 having an annular shape.

The first reflecting surface 16 reflects the ultrasonic wave generated at the ultrasonic wave generation source 11, toward the second reflecting surface 17. The second reflecting surface 17 reflects the ultrasonic wave reflected by the first reflecting surface 16, toward a rear end portion of the waveguide 13. The first reflecting surface 16 and the second reflecting surface 17 are arranged such that the ultrasonic wave reflected by the second reflecting surface 17 as a plane wave is introduced into the waveguide 13.

The waveguide 13 has a shape extending forward from the front end of the ultrasonic wave converging portion 12. That is, the waveguide 13 extends in a direction where an ultrasonic wave radiates from the ultrasonic wave generation source 11. In the present embodiment, the waveguide 13 and the ultrasonic wave converging portion 12 are described as different members, but may be formed as one member.

The waveguide 13 includes a first shaft portion 21, a second shaft portion 22, and a jutting out portion 30.

The first shaft portion 21 extends from the ultrasonic wave converging portion 12 to one side in a predetermined direction. The “predetermined direction” is the “front-rear direction” in the present embodiment, and the “one side in the predetermined direction” is the “front side” in the present embodiment. That is, the first shaft portion 21 extends forward from the ultrasonic wave converging portion 12. The first shaft portion 21 has a columnar shape, more specifically, a circular columnar shape. In the first shaft portion 21, each of the sections cut in a direction orthogonal to the front-rear direction (hereinafter, referred to simply as a “section”) has a uniform shape and a constant area in the front-rear direction. The section of the first shaft portion 21 has a circular shape.

The second shaft portion 22 is provided on the front side relative to the first shaft portion 21 and extends forward. The second shaft portion 22 has a columnar shape, more specifically, a circular columnar shape. In the second shaft portion 22, each of the sections cut in a direction orthogonal to the front-rear direction (hereinafter, referred to simply as a “section”) has a uniform shape and a constant area in the front-rear direction. The section of the second shaft portion 22 has the same shape as the section of the first shaft portion 21 and thus has a circular shape. The section of the second shaft portion 22 has the same area as the section of the first shaft portion 21.

The first shaft portion 21 and the second shaft portion 22 constitute a waveguide main body 20. The waveguide main body 20 has a shape extending forward from the ultrasonic wave converging portion 12. The waveguide main body 20 has a columnar shape, more specifically, a circular columnar shape. In the waveguide main body 20, each of the sections cut in a direction orthogonal to the front-rear direction (hereinafter, referred to simply as a “section”) has a uniform shape and a constant area in the front-rear direction. The section of the waveguide main body 20 has a circular shape. The waveguide main body 20 is preferably formed of a material having high ultrasonic wave propagation performance, and is preferably formed of, for example, an aluminum alloy or a metallic glass. The waveguide main body 20 may be formed of a shape-memory alloy made of, for example, an alloy of titanium and nickel. The waveguide main body 20 is elastically deformable.

Between the first shaft portion 21 and the second shaft portion 22 in the front-rear direction, a third shaft portion 23 is provided. The third shaft portion 23 constitutes the waveguide main body 20 along with the first shaft portion 21 and the second shaft portion 22. The third shaft portion 23 has a columnar shape, more specifically, a circular columnar shape. In the third shaft portion 23, each of the sections, cut in a direction orthogonal to the front-rear direction (hereinafter, referred to simply as a “section”) has a uniform shape and a constant area in the front-rear direction. The section of the third shaft portion 23 has the same shape as the sections of the first shaft portion 21 and the second shaft portion 22 and thus has a circular shape. The section of the third shaft portion 23 has the same area as the sections of the first shaft portion 21 and the second shaft portion 22.

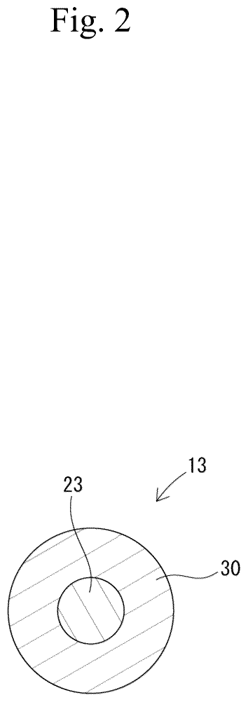

As illustrated in FIGS. 1 and 2, the jutting out portion 30 is constituted by a different member from the waveguide main body 20 and covers the outer circumference of the waveguide main body 20 (more specifically, the third shaft portion 23) over the entire circumference. The jutting out portion 30 is provided between the first shaft portion 21 and the second shaft portion 22 in the front-rear direction. The jutting out portion 30 has an annular shape, more specifically, a circular annular shape. In a plane direction orthogonal to the front-rear direction, the jutting out portion 30 juts out more outward than both the outer circumferential surface of the first shaft portion 21 and the outer circumferential surface of the second shaft portion 22. In the waveguide 13, the jutting out portion 30 constitutes a large diameter portion having an outside diameter larger than the first shaft portion 21 and the second shaft portion 22. When viewed in a direction orthogonal to the front-rear direction, the jutting out portion 30 has a rectangular shape. The material of the jutting out portion 30 may be the same as or may differ from the material of the waveguide main body 20. The jutting out portion 30 is formed of, for example, a resin such as plastic.

The Jutting Out Portion 30 Includes an Installation portion 31 which is held on the outer circumferential surface of the waveguide main body 20 (more specifically, the third shaft portion 23). The installation portion 31 is fixed to the waveguide main body 20 by using, for example, an adhesive. The installation portion 31 is in contact with the outer circumferential surface of the waveguide main body 20 over the entire circumference.

### 1-2. Examples of Actions and Effects of Ultrasonic Generator 10

The ultrasonic wave generation source 11 generates an ultrasonic wave forward from the radiating surface 15 when receiving an electrical signal from the signal transmitting and receiving circuit, which is not illustrated. The ultrasonic wave radiating from the radiating surface 15 is reflected by the first reflecting surface 16 and converges to the focus of the first reflecting surface 16. The focus of the first reflecting surface 16 is the same as the focus of the second reflecting surface 17. Thus, the ultrasonic wave passing though the focus of the first reflecting surface 16 is reflected by the second reflecting surface 17 and is introduced inside the waveguide 13 as a plane wave. The ultrasonic wave introduced to the inside of the waveguide 13 is transmitted inside the waveguide 13 (more specifically, the waveguide main body 20) and radiates from the front end of the waveguide 13.

According to the configuration, the ultrasonic wave generated from the ultrasonic wave generation source 11 can be converged while being less attenuated, and can be introduced into the waveguide 13 as a plane wave. Moreover, since the waveguide 13 includes the jutting out portion 30, an external object comes into contact with the jutting out portion 30, thereby being less likely to come into contact with the first shaft portion 21 and the second shaft portion 22. That is, a region where the waveguide 13 comes into contact with the external object is limited to a part of the waveguide 13. Thus, according to the configuration, it is possible to reduce a leakage of the ultrasonic wave propagating through the waveguide 13 to the outside.

Moreover, the jutting out portion 30 is formed such that the installation portion 31, which is a different member from the waveguide main body 20 constituting the first shaft portion 21 and the second shaft portion 22, is held on the outer circumferential surface of the waveguide main body 20. According to the configuration, the jutting out portion 30 and the waveguide main body 20 can be made different in material.

### 2. Second Embodiment

In a second embodiment, the configuration including a covering portion provided on the outer circumferential surface of the jutting out portion will be described.

In the following description, the same components as those in the first embodiment are denoted by the same reference signs, and the detailed description thereof will be omitted.

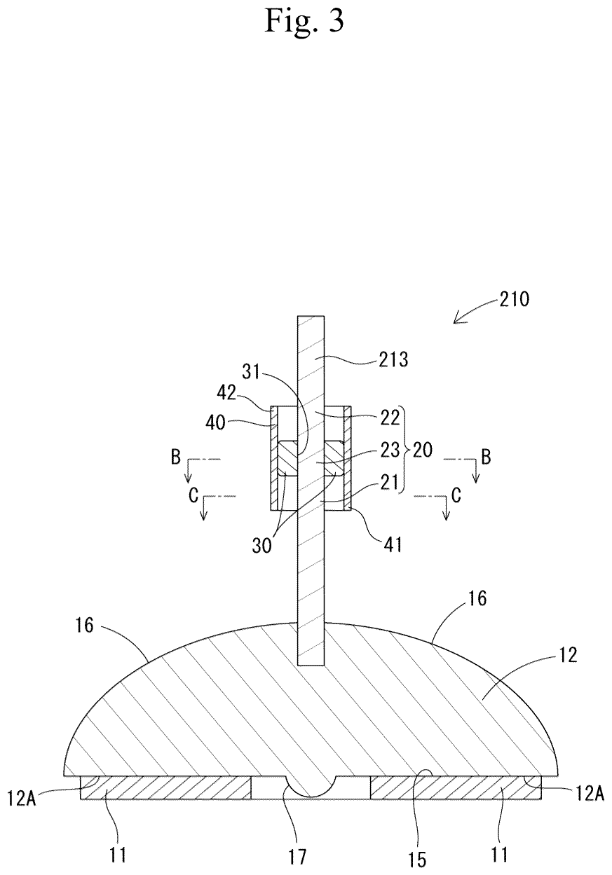

As illustrated in FIG. 3, an ultrasonic generator 210 in the second embodiment includes an ultrasonic wave generation source 11, an ultrasonic wave converging portion 12, and a waveguide 213.

The waveguide 213 includes a first shaft portion 21, a second shaft portion 22, and a third shaft portion 23. The first shaft portion 21, the second shaft portion 22, and the third shaft portion 23 constitute a waveguide main body 20.

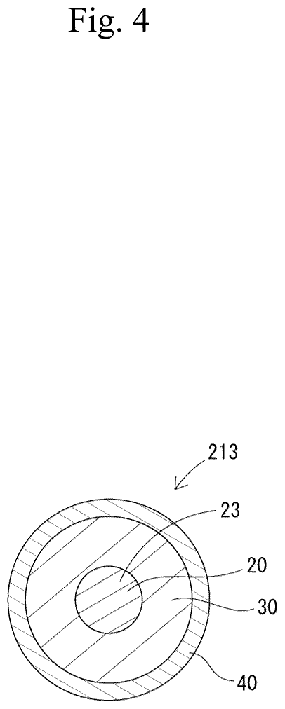

As illustrated in FIGS. 3 and 4, the waveguide 213 includes a jutting out portion 30 and a covering portion 40. The covering portion 40 has an annular shape, more specifically, a circular annular shape. The covering portion 40 is a different member from the jutting out portion 30 and covers the outer circumference of the jutting out portion 30 over the entire circumference. The covering portion 40 is held on the jutting out portion 30. The covering portion 40 is fixed to the jutting out portion 30 by using an adhesive. The covering portion 40 has a thickness smaller than the jutting out portion 30. In the front-rear direction, the covering portion 40 has a length greater than the jutting out portion 30.

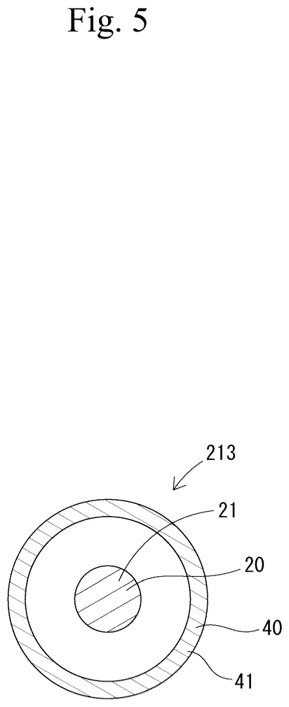

The covering portion 40 includes a rear-side covering portion 41 disposed on the rear side relative to the rear end of the jutting out portion 30. The rear-side covering portion 41 has an annular shape, more specifically, a circular annular shape. As illustrated in FIG. 5, a clearance is formed between the inner circumferential surface of the rear-side covering portion 41 and the outer circumferential surface of the first shaft portion 21 over the entire circumference. The covering portion 40 includes a front-side covering portion 42 disposed on the front side relative to the front end of the jutting out portion 30. The front-side covering portion 42 has an annular shape, more specifically, a circular annular shape. Like the clearance illustrated in FIG. 5, a clearance is formed between the inner circumferential surface of the front-side covering portion 42 and the outer circumferential surface of the second shaft portion 22 over the entire circumference.

According to the configuration, even when an external object comes into contact with the outer circumferential surface of the rear-side covering portion 41, there is a clearance between the first shaft portion 21 and the external object. Thus, it is possible to reduce a leakage of the ultrasonic wave propagating through the first shaft portion 21 to the outside. In addition, according to the configuration, even when an external object comes into contact with the outer circumferential surface of the front-side covering portion 42, there is a clearance between the second shaft portion 22 and the external object. Thus, it is possible to reduce a leakage of the ultrasonic wave propagating through the second shaft portion 22 to the outside.

### 3. Third Embodiment

In a third embodiment, the configuration in which the jutting out portion includes an extension portion will be described. In the following description, the same components as those in the first embodiment are denoted by the same reference signs, and the detailed description thereof will be omitted.

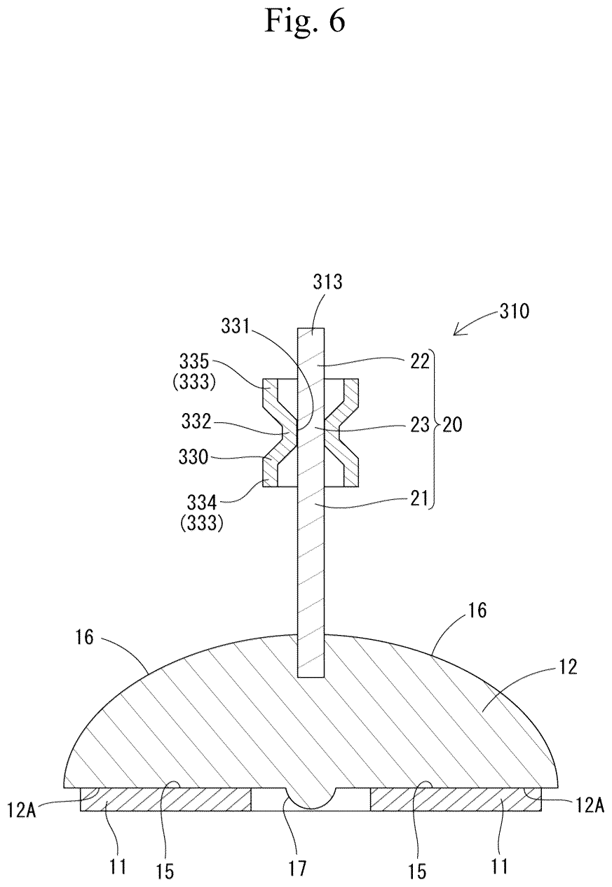

As illustrated in FIG. 6, an ultrasonic generator 310 in the third embodiment includes an ultrasonic wave generation source 11, an ultrasonic wave converging portion 12, and a waveguide 313.

The waveguide 313 includes a first shaft portion 21, a second shaft portion 22, and a third shaft portion 23. The first shaft portion 21, the second shaft portion 22, and the third shaft portion 23 constitute a waveguide main body 20.

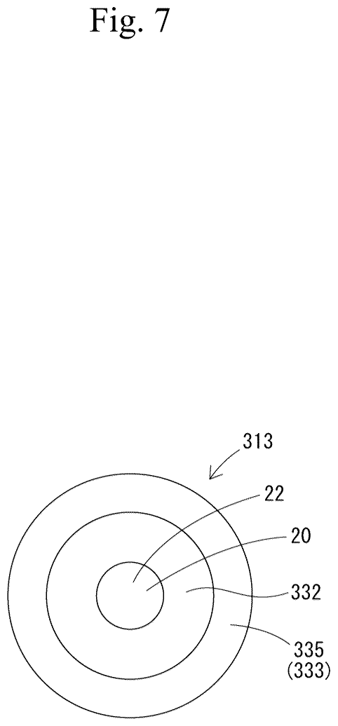

As illustrated in FIGS. 6 and 7, the waveguide 313 includes a jutting out portion 330. The jutting out portion 330 is constituted by a different member from the waveguide main body 20 and covers the outer circumference of the waveguide main body 20 (more specifically, the third shaft portion 23) over the entire circumference. The material of the jutting out portion 330 may be the same as or may differ from the material of the waveguide main body 20. The jutting out portion 330 is formed of a resin such as plastic, for example.

The jutting out portion 330 is provided between the first shaft portion 21 and the second shaft portion 22 in the front-rear direction. The jutting out portion 330 has an annular shape. In the plane direction orthogonal to the front-rear direction, the jutting out portion 330 juts out more outward than both the outer circumferential surface of the first shaft portion 21 and the outer circumferential surface of the second shaft portion 22.

The jutting out portion 330 includes an installation portion 331 held on the outer circumferential surface of the waveguide main body 20 (more specifically, the third shaft portion 23). The installation portion 331 is fixed to the waveguide main body 20 by using, for example, an adhesive. The installation portion 331 includes a contact portion 332 and an extension portion 333.

The contact portion 332 is a portion that is in contact with the outer circumferential surface of the waveguide main body 20 (more specifically, the third shaft portion 23). The contact portion 332 has an annular shape. The inner circumferential surface of the contact portion 332 is in contact with the outer circumferential surface of the waveguide main body 20.

The extension portion 333 extends from the contact portion 332 in the front-rear direction and covers a part of the outer circumferential surface of the waveguide main body 20 (more specifically, the third shaft portion 23) with a clearance interposed therebetween. The extension portion 333 has an annular shape and covers the outer circumferential surface of the waveguide main body 20 over the entire circumference. The extension portion 333 includes a rear-side extension portion 334 extending rearward from the contact portion 332 and covering a part of the outer circumferential surface of the waveguide main body 20 (more specifically, the third shaft portion 23) with a clearance interposed therebetween. The rear-side extension portion 334 has an annular shape and covers the outer circumferential surface of the waveguide main body 20 over the entire circumference. The extension portion 333 includes a front-side extension portion 335 extending forward from the contact portion 332 and covering a part of the outer circumferential surface of the waveguide main body 20 (more specifically, the third shaft portion 23) with a clearance interposed therebetween. The front-side extension portion 335 has an annular shape and covers the outer circumferential surface of the waveguide main body 20 over the entire circumference.

According to the configuration, when an external object comes into contact with the outer circumferential surface of the extension portion 333, there is a clearance between the external object and the waveguide main body 20 (more specifically, the third shaft portion 23). Thus, even when the external object comes into contact with the outer circumferential surface of the extension portion 333, it is possible to reduce a leakage of the ultrasonic wave propagating through the waveguide main body 20 to the outside.

### 4. Fourth Embodiment

The first to third embodiments have the configuration in which the jutting out portion covers the outer circumferential surface of the waveguide main body. On the other hand, in a fourth embodiment, the configuration in which a cover that is a different member from the waveguide covers the outer circumferential surface of the waveguide will be described. In the following description, the same components as those in the first embodiment are denoted by the same reference signs, and the detailed description thereof will be omitted.

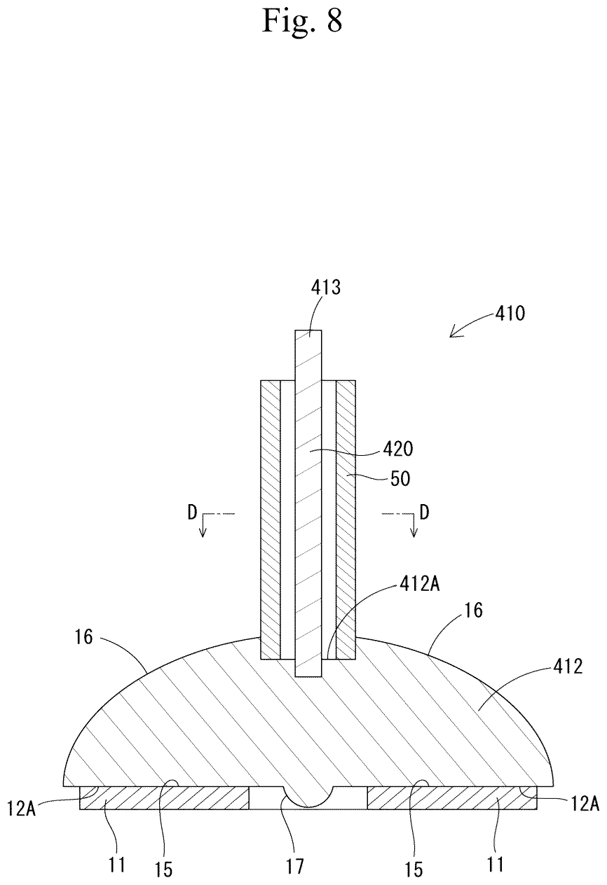

As illustrated in FIG. 8, an ultrasonic generator 410 in the fourth embodiment includes an ultrasonic wave generation source 11, an ultrasonic wave converging portion 412, a waveguide 413, and a cover 50.

The ultrasonic wave converging portion 412 differs from the ultrasonic wave converging portion 12 in the first embodiment in that a recessed portion 412A in which the cover 50 is installed is formed, but has the same configuration as the ultrasonic wave converging portion 12 in other respects. The recessed portion 412A is formed on the front surface of the ultrasonic wave converging portion 412 and is open to the front side. The recessed portion 412A has an annular shape, more specifically, a circular annular shape. The recessed portion 412A surrounds the outer circumference of the waveguide 413.

The waveguide 413 includes a shaft portion 420 extending from the ultrasonic wave converging portion 412 to one side in a predetermined direction. The “predetermined direction” is the “front-rear direction” in the present embodiment, and the “one side in the predetermined direction” is the “front side” in the present embodiment. That is, the shaft portion 420 extends forward from the ultrasonic wave converging portion 412. The shaft portion 420 has the same configuration as the waveguide main body 20 described in the first embodiment.

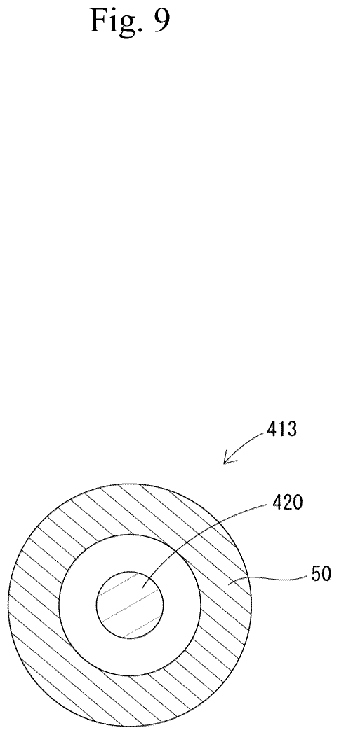

In the present embodiment, the cover 50 and the ultrasonic wave converging portion 412 are different members, but may be formed as one member. As illustrated in FIGS. 8 and 9, the cover 50 has a cylindrical shape, more specifically, a circular cylindrical shape. The cover 50 is made of, for example, a synthetic resin. The cover 50 is fixed while being fitted in the recessed portion 412A of the ultrasonic wave converging portion 412. The cover 50 is adhered to the recessed portion 412A by using, for example, an adhesive. The cover 50 extends forward from the ultrasonic wave converging portion 412. The cover 50 has an inside diameter larger than the diameter of the shaft portion 420. The cover 50 is disposed around the waveguide 413 (more specifically, the shaft portion 420) with a clearance interposed therebetween. The front end of the cover 50 is disposed on the rear side relative to the front end of the waveguide 413.

According to the ultrasonic generator 410 in the fourth embodiment, the ultrasonic wave generated from the ultrasonic wave generation source 11 can be converged while being less attenuated, and can be introduced into the waveguide 413 as a plane wave. Moreover, the ultrasonic generator 410 includes the cover 50 disposed around the shaft portion 420 with a clearance interposed therebetween. Thus, it is possible to prevent an external object from coming into contact with the shaft portion 420. In addition, even when the external object comes into contact with the cover 50, the ultrasonic wave propagating through the shaft portion 420 is less likely to leak to the external object. Thus, according to the ultrasonic generator 410, it is possible to reduce a leakage of the ultrasonic wave propagating through the waveguide 413 to the outside.

### 5. Fifth Embodiment

In a fifth embodiment, the configuration in which the cover described in the fourth embodiment is fixed to a case, not to the ultrasonic wave converging portion will be described. In the following description, the same components as those in the first embodiment are denoted by the same reference signs, and the detailed description thereof will be omitted.

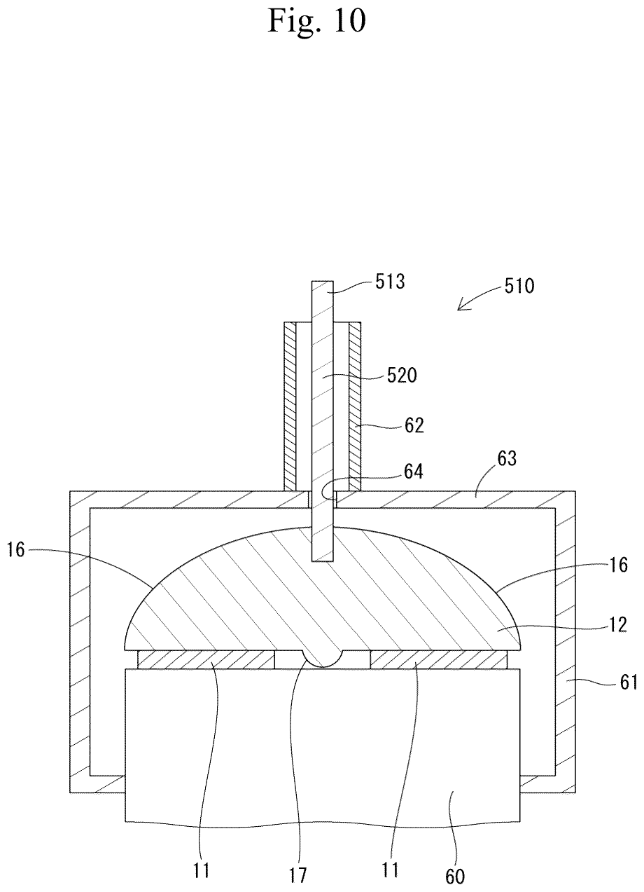

As illustrated in FIG. 10, an ultrasonic generator 510 in the fifth embodiment includes an ultrasonic wave generation source 11, an ultrasonic wave converging portion 12, and a waveguide 513.

The waveguide 513 includes a shaft portion 520 extending from the ultrasonic wave converging portion 12 to one side in a predetermined direction. The “predetermined direction” is the “front-rear direction” in the present embodiment, and the “one side in the predetermined direction” is the “front side” in the present embodiment. That is, the shaft portion 520 extends forward from the ultrasonic wave converging portion 12. The shaft portion 520 has the same configuration as the waveguide main body 20 described in the first embodiment.

As illustrated in FIG. 10, the ultrasonic generator 510 includes a base portion 60, a support portion 61, and a cover 62. The base portion 60 is disposed on the rear side relative to the ultrasonic wave generation source 11. The front surface of the base portion 60 is joined to the rear surface of the ultrasonic wave generation source 11. Here, “joined” includes not only being directly joined but also being joined via another member.

The support portion 61 has a box shape covering the ultrasonic wave generation source 11 and the ultrasonic wave converging portion 12. The support portion 61 is fixed to the base portion 60. The support portion 61 includes a front wall portion 63 which is disposed on the front side relative to the ultrasonic wave converging portion 12 and on the rear side relative to the front end of the shaft portion 520. The front wall portion 63 has a through hole 64 passing therethrough in the front-rear direction. The waveguide 513 is inserted into the through hole 64. The cover 62 is fixed to the front wall portion 63.

The cover 62 has a cylindrical shape, more specifically, a circular cylindrical shape. The cover 62 is made of, for example, a synthetic resin. The cover 62 is fixed to the front wall portion 63 of the support portion 61. The cover 62 is adhered to the front wall portion 63 by using, for example, an adhesive. The cover 62 extends forward from the support portion 61 (more specifically, the front wall portion 63). The cover 62 has an inside diameter larger than the diameter of the shaft portion 520. The cover 62 is disposed around the waveguide 513 (more specifically, the shaft portion 520) with a clearance interposed therebetween. The front end of the cover 62 is disposed on the rear side relative to the front end of the waveguide 513.

According to the ultrasonic generator 510 in the fifth embodiment, the ultrasonic wave generated from the ultrasonic wave generation source 11 can be converged while being less attenuated, and can be introduced into the waveguide 513 as a plane wave. Moreover, the ultrasonic generator 510 includes the cover 62 disposed around the shaft portion 520 with a clearance interposed therebetween. Thus, it is possible to prevent an external object from coming into contact with the shaft portion 520. In addition, even when the external object comes into contact with the cover 62, the ultrasonic wave propagating through the shaft portion 520 is less likely to leak to the external object. Thus, according to the ultrasonic generator 510, it is possible to reduce a leakage of the ultrasonic wave propagating through the waveguide 513 to the outside.

### 6. Sixth Embodiment

In a sixth embodiment, the configuration in which the outer circumference of the waveguide is covered with a first cover and a second cover will be described. In the following description, the same components as those in the first embodiment are denoted by the same reference signs, and the detailed description thereof will be omitted.

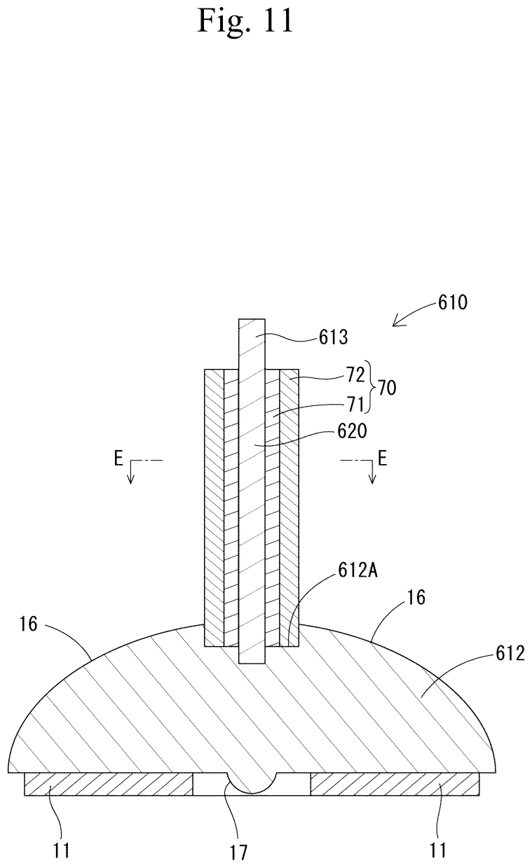

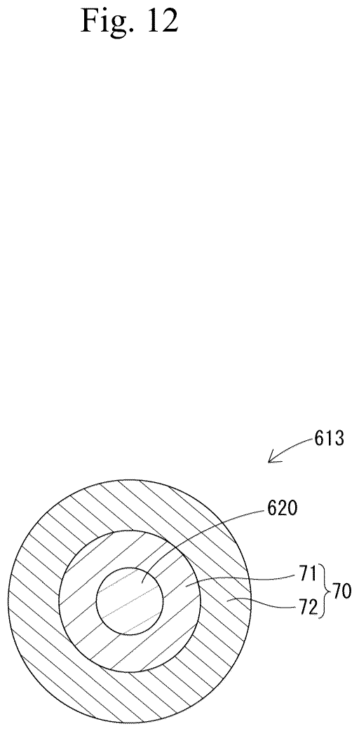

As illustrated in FIGS. 11 and 12, an ultrasonic generator 610 in the sixth embodiment includes an ultrasonic wave generation source 11, an ultrasonic wave converging portion 612, a waveguide 613, a first cover 71, and a second cover 72.

The ultrasonic wave converging portion 612 differs from the ultrasonic wave converging portion 12 in the first embodiment in that there is formed a recessed portion 612A to which the waveguide 613, the first cover 71, and the second cover 72 are fixed, but has the same configuration as the ultrasonic wave converging portions 12 in other respects.

The waveguide 613 includes a shaft portion 620 extending from the ultrasonic wave converging portion 612 to one side in a predetermined direction. The “predetermined direction” is the “front-rear direction” in the present embodiment, and the “one side in the predetermined direction” is the “front side” in the present embodiment. That is, the shaft portion 620 extends forward from the ultrasonic wave converging portion 612. The shaft portion 620 has the same configuration as the waveguide main body 20 described in the first embodiment.

The waveguide 613 further includes a cover 70 covering the outer circumference of the shaft portion 620. The cover 70 is constituted by the first cover 71 and the second cover 72. The first cover 71 has a cylindrical shape, more specifically, a circular cylindrical shape. The first cover 71 covers the outer circumference of the shaft portion 620 while being in contact with the outer circumferential surface of the shaft portion 620. The first cover 71 is held on the outer circumferential surface of the shaft portion 620. The first cover 71 is adhered to the outer circumferential surface of the shaft portion 620 by using, for example, an adhesive. The front end of the first cover 71 is disposed on the rear side relative to the front end of the shaft portion 620.

The second cover 72 has a cylindrical shape, more specifically, a circular cylindrical shape. The second cover 72 covers the outer circumference of the shaft portion 620 while being in contact with the outer circumferential surface of the first cover 71. The second cover 72 is held on the outer circumferential surface of the first cover 71. The second cover 72 is adhered by using, for example, an adhesive. The front end of the second cover 72 is disposed on the rear side relative to the front end of the shaft portion 620.

The first cover 71 and the second cover 72 are fixed while being fitted in the recessed portion 612A of the ultrasonic wave converging portion 612. A fixing method is, for example, adhesion with an adhesive.

The value of the acoustic impedance of the first cover 71 is more than or less than both the values of the acoustic impedance of the shaft portion 620 and the acoustic impedance of the second cover 72. In the present embodiment, the shaft portion 620 and the second cover 72 are made of the same material and have the same acoustic impedance. On the other hand, the first cover 71 differ in material and in acoustic impedance from the shaft portion 620 and the second cover 72. The shaft portion 620 and the second cover 72 are made of, for example, an aluminum alloy, and the first cover 71 is made of, for example, a synthetic resin.

According to the configuration, the ultrasonic wave generated from the ultrasonic wave generation source 11 can be converged while being less attenuated, and can be introduced into the waveguide 613 as a plane wave. Moreover, the first cover 71 is disposed between the shaft portion 620 of the waveguide 613 and the second cover 72, so that an ultrasonic wave is less likely to propagate between the shaft portion 620 and the second cover 72. Thus, even when an external object comes into contact with the second cover 72, it is possible to make the ultrasonic wave propagating through the shaft portion 620 less likely to leak to the external object through the second cover 72. Thus, according to the configuration, it is possible to reduce a leakage of the ultrasonic wave propagating through the waveguide 613 to the outside.

### 7. Seventh Embodiment

In a seventh embodiment, the configuration of a waveguide 713 including a shaft portion 711 and a cover 712 will be described. In the following description, the same components as those in the first embodiment are denoted by the same reference signs, and the detailed description thereof will be omitted.

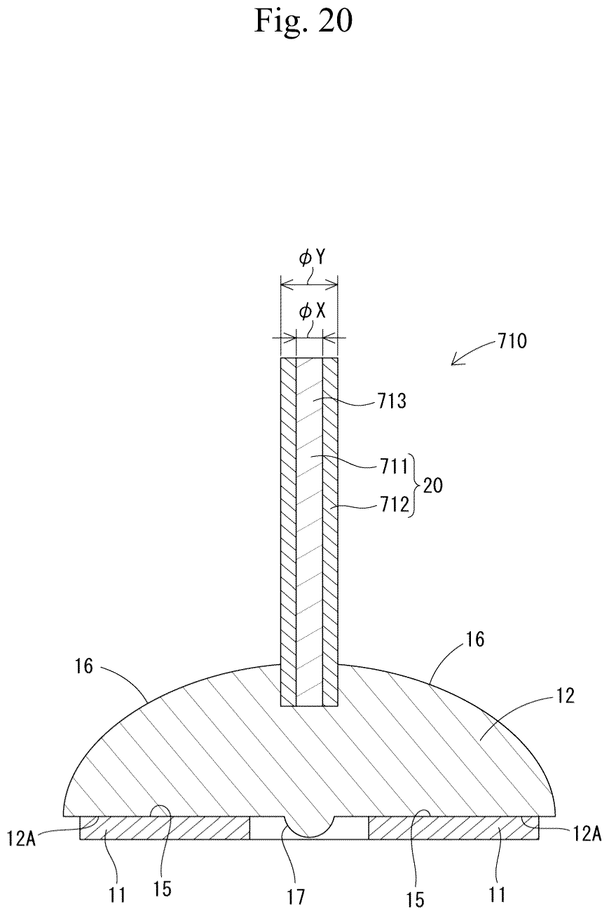

As illustrated in FIG. 20, an ultrasonic generator 710 in the seventh embodiment includes an ultrasonic wave generation source 11, an ultrasonic wave converging portion 12, and the waveguide 713.

The waveguide 713 includes the shaft portion 711 and the cover 712 that extend from the ultrasonic wave converging portion 12 to one side in a predetermined direction. The “predetermined direction” is the “front-rear direction” in the present embodiment, and the “one side in the predetermined direction” is the “front side” in the present embodiment. That is, the shaft portion 711 and the cover 712 extend forward from the ultrasonic wave converging portion 12.

The shaft portion 711 and the cover 712 constitute a waveguide main body 20. The shaft portion 711 and the cover 712 are formed by different materials. The wave propagation velocity in the shaft portion 711 is slower than the wave propagation velocity in the cover 712. Thus, ultrasonic waves propagate inside the waveguide 713 while concentrating in the shaft portion 711 where the wave propagation velocity is slow.

The wave propagation velocity in the cover 712 is preferably in the range of 1.3 to 1.7 times the wave propagation velocity in the shaft portion 711. The wave propagation velocity in the cover 712 is more preferably about 1.5 times the wave propagation velocity in the shaft portion 711. In this case, ultrasonic waves are more likely to concentrate in the shaft portion 711.

The shaft portion 711 has a circular columnar shape extending in the front-rear direction while including the central axis of the waveguide 713. A diameter φX of the shaft portion 711 is preferably 1 mm to 2 mm. The shaft portion 711 is preferably formed by using a material having less vibration attenuation.

The cover 712 covers the shaft portion 711 while being in contact with the outer circumferential surface of the shaft portion 711 and integrated with the shaft portion 711. The cover 712 has a circular cylindrical shape coaxial with the shaft portion 711. A diameter φY of the waveguide 713 including the cover 712 is preferably about 5 mm.

At the front end of the waveguide 713, the shaft portion 711 may be exposed outside, or may be covered with the same material as the material forming the cover 712. Further, a different member from the waveguide 713 may be attached to the front end of the waveguide 713 to cover the front end surface of the waveguide 713.

The shaft portion 711 of the waveguide 713 is formed of a material having a slow wave propagation velocity, and the cover 712 is formed of a material having a fast wave propagation velocity. Specific examples of the combination of the materials of the shaft portion 711 and the cover 712 will be described.

As a first example, a metallic glass can be used as the material of the shaft portion 711. An example of a metallic glass may be a metallic glass (Zr55Cu30A110Ni5) manufactured by Orbray Co., Ltd. In this case, the material of the cover 712 to be used is preferably aluminum or titanium. When a metallic glass is used as the material of the shaft portion 711 and aluminum is used the material of the cover 712, the wave propagation velocity in the cover 712 is about 1.5 times the wave propagation velocity in the shaft portion 711. With this configuration, ultrasonic waves can be effectively confined inside the waveguide 713 so that a leakage of the ultrasonic wave from the waveguide 713 to the outside can be reduced.

As a second example, a quartz pipe can be used for the cover 712. In this case, the shaft portion 711 may be formed of a metal material. As a third example, boron oxide (B2O3) may be used as the material of the shaft portion 711, and silicon dioxide (SiO2) may be used as the material of the cover 712.

An example of a manufacturing method for the waveguide 713 will be described. A first example is a method in which the cover 712 is formed after the shaft portion 711 is formed. Specifically, for example, the cover 712 is formed on the already formed shaft portion 711 by thermal spraying or plating. A second example is a method in which the shaft portion 711 is formed after the cover 712 is formed. Specifically, for example, the shaft portion 711 is formed by being poured into an inner space of the already formed cylindrical cover 712. The manufacturing method for the waveguide 713 is not limited to the above-described methods, and a method may be appropriately selected according to the materials of the shaft portion 711 and the cover 712.

According to the ultrasonic generator 710 in the seventh embodiment, the ultrasonic wave generated from the ultrasonic wave generation source 11 can be converged while being less attenuated, and can be introduced into the waveguide 713 as a plane wave. Moreover, since the propagation of ultrasonic waves can be concentrated in the shaft portion 711, energy leakage through the side surface of the waveguide 713 can be reduced. In addition, the wave propagation velocity in the cover 712 is set in the range of 1.3 to 1.7 times the wave propagation velocity in the shaft portion 711, whereby ultrasonic waves can be further concentrated in the shaft portion 711. Thus, according to the ultrasonic generator 710, it is possible to reduce a leakage of the ultrasonic wave propagating through the waveguide 713 to the outside.

### OTHER EMBODIMENTS

The present invention is not limited to the embodiments described by the above description with reference to the drawings, and, for example, the following embodiments are also included within the technical scope of the present invention. In addition, various features of the above-described embodiments and the following embodiments may be combined in any way as long as no contradiction arises.

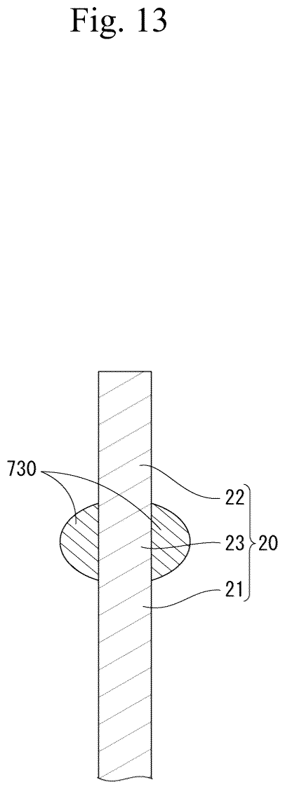

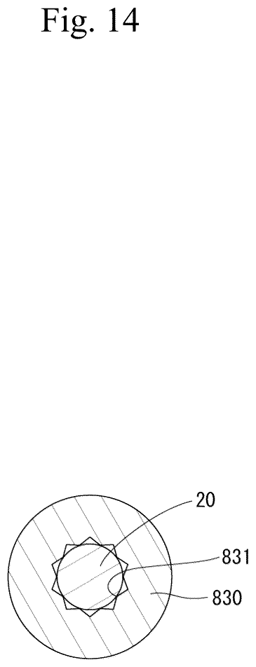

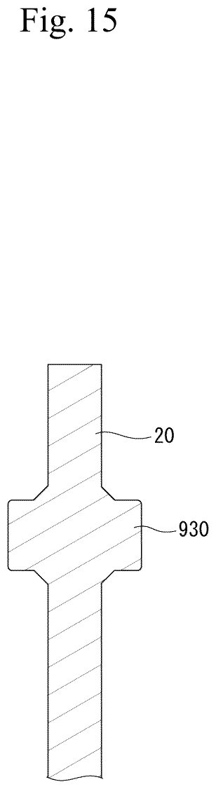

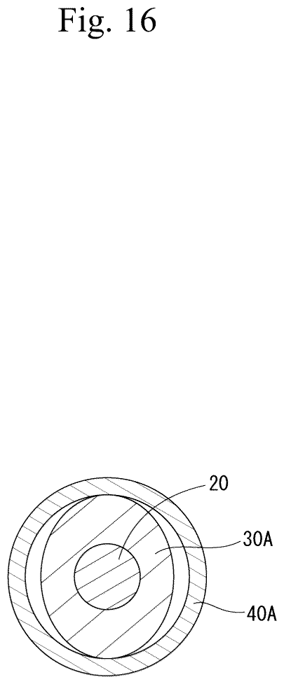

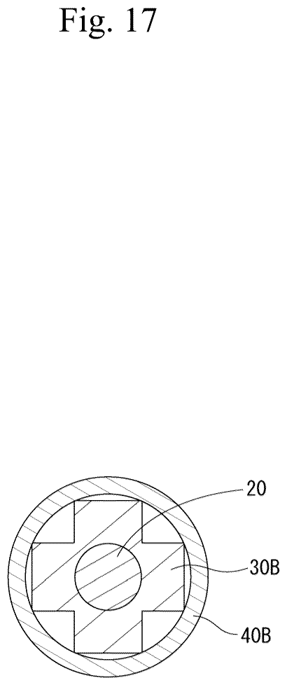

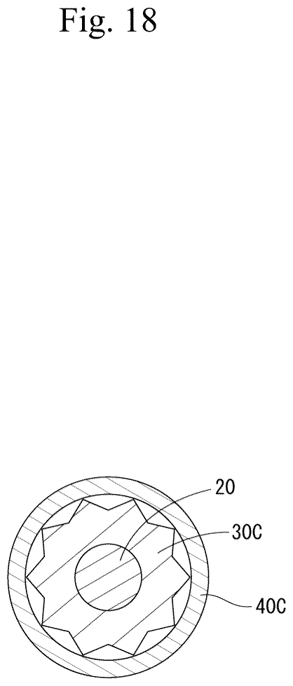

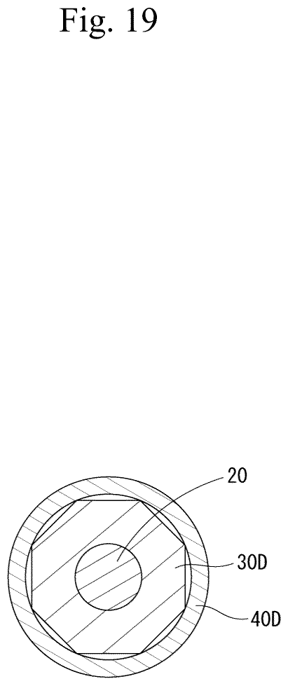

(1) In the first to third embodiments above, the shape of the section of each of the first shaft portion, the second shaft portion, the third shaft portion, and the waveguide main body is circular, but is not necessarily circular. For example, the shape of the section of each of the first shaft portion, the second shaft portion, the third shaft portion, and the waveguide main body may be oval or may be rectangular.
(2) In the first to third embodiments above, the shapes of the sections of the first shaft portion, the second shaft portion, and the third shaft portion are the same, but are not necessarily the same. For example, the shape of the section of the first shaft portion may differ from the shape of the section of the second shaft portion. The shape of the section of the third shaft portion may differ from the shape of the section of the first shaft portion and/or may differ from the shape of the section of the second shaft portion.
(3) In the fourth to sixth embodiments above, the shape of the section of the shaft portion is circular, but is not necessarily circular. For example, the shape of the section of the shaft portion may be oval or may be rectangular.
(4) In the first embodiment above, the shape of the jutting out portion when viewed in a direction orthogonal to the front-rear direction is rectangular, but may be a different shape (such as an oval shape) like a jutting out portion 730 illustrated in FIG. 13.
(5) In the first to third embodiments above, the jutting out portion is in contact with the outer circumferential surface of the waveguide main body over the entire circumference, but only a part of the jutting out portion in the circumferential direction may be in contact therewith. For example, as illustrated in FIG. 14, only a part of a jutting out portion 830 in the circumferential direction may be in contact with the outer circumferential surface of the waveguide main body 20. According to the configuration, a leakage of the ultrasonic wave from the waveguide main body 20 to an installation portion 831 can be reduced. Thus, even when an external object comes into contact with the jutting out portion 830 including the installation portion 831, it is possible to reduce a leakage of the ultrasonic wave propagating through the waveguide main body 20 to the external object through the jutting out portion 830.
(6) In the first to third embodiments above, the jutting portion and the waveguide main body are different members, but may be formed as one member. For example, as illustrated in FIG. 15, a jutting out portion 930 and the waveguide main body 20 may be formed as one member.
(7) In the second embodiment above, the covering portion is in contact with the outer circumferential surface of the jutting out portion over the entire circumference, but only a part of the covering portion in the circumferential direction may be in contact therewith. For example, as illustrated in FIG. 16, only a part of a covering portion 40A in the circumferential direction may be in contact with the outer circumferential surface of a jutting out portion 30A. In addition, as illustrated in FIG. 17, only a part of a covering portion 40B in the circumferential direction may be in contact with the outer circumferential surface of a jutting out portion 30B. In addition, as illustrated in FIG. 18, only a part of a covering portion 40C in the circumferential direction may be in contact with the outer circumferential surface of a jutting out portion 30C. In addition, as illustrated in FIG. 19, only a part of a covering portion 40D in the circumferential direction may be in contact with the outer circumferential surface of a jutting out portion 30D.
(8) In the fifth embodiment above, the front surface of the base portion 60 is joined to the rear surface of the ultrasonic wave generation source 11. However, a flange may be provided on the outer circumference of the ultrasonic wave converging portion 12 and may be fixed to the support portion 61.
(9) In the sixth embodiment above, the first cover and the second cover are fixed to the ultrasonic wave converging portion, but are not necessarily fixed to the ultrasonic wave converging portion. For example, the first cover and the second cover may be held only on the waveguide.

Notably, it should be understood that the embodiments disclosed herein are illustrative and are not limiting in all respects. The scope of the present invention is not limited to the embodiments disclosed herein and is intended to include all modifications within the scope stated in the claims or the scope equivalent to the claims.

### REFERENCE SIGNS LIST

10 ultrasonic generator
11 ultrasonic wave generation source
12 ultrasonic wave converging portion
13 waveguide
16 first reflecting surface
17 second reflecting surface
20 waveguide main body
21 first shaft portion
22 second shaft portion
30 jutting out portion
30A jutting out portion
30B jutting out portion
30C jutting out portion
30D jutting out portion
31 installation portion
40 covering portion
40A covering portion
40B covering portion
40C covering portion
40D covering portion
50 cover
62 cover
70 cover
71 first cover
72 second cover
210 ultrasonic generator
213 waveguide
310 ultrasonic generator
313 waveguide
330 jutting out portion
331 installation portion
333 extension portion
410 ultrasonic generator
412 ultrasonic wave converging portion
412A recessed portion
413 waveguide
420 shaft portion
510 ultrasonic generator
513 waveguide
520 shaft portion
610 ultrasonic generator
612 ultrasonic wave converging portion
613 waveguide
620 shaft portion
710 ultrasonic generator
711 shaft portion
712 cover
713 waveguide
730 jutting out portion
830 jutting out portion
831 installation portion
930 jutting out portion

1. An ultrasonic generator comprising:
an ultrasonic wave generation source that generates an ultrasonic wave;
an ultrasonic wave converging portion that converges the ultrasonic wave generated from the ultrasonic wave generation source; and
a waveguide that transmits the ultrasonic wave converged by the ultrasonic wave converging portion,
the ultrasonic wave converging portion including
a first reflecting surface that reflects the ultrasonic wave generated at the ultrasonic wave generation source, and
a second reflecting surface that reflects the ultrasonic wave reflected by the first reflecting surface,
the first reflecting surface and the second reflecting surface being arranged such that the ultrasonic wave reflected by the second reflecting surface as a plane wave is introduced into the waveguide, wherein
the waveguide includes a first shaft portion extending from the ultrasonic wave converging portion to one side in a predetermined direction, a second shaft portion disposed on the one side in the predetermined direction relative to the first shaft portion and extending in the predetermined direction, and a jutting out portion provided between the first shaft portion and the second shaft portion in the predetermined direction, and
the jutting out portion juts out more outward than outer circumferential surfaces of the first shaft portion and the second shaft portion in a plane direction orthogonal to the predetermined direction.

2. The ultrasonic generator according to claim 1, wherein
the waveguide includes a covering portion covering at least a part of the outer circumferential surfaces of the first shaft portion and the second shaft portion with a clearance interposed between the covering portion and the part of the outer circumferential surfaces of the first shaft portion and the second shaft portion, and
the covering portion is held on the jutting out portion.

3. The ultrasonic generator according to claim 1, wherein
the waveguide includes a covering portion covering at least a part of an outer circumferential surface of the jutting out portion and having a cylindrical shape, and
the covering portion is held on the outer circumferential surface of the jutting out portion with a part of the covering portion in a circumferential direction being in contact with the outer circumferential surface of the jutting out portion.

4. The ultrasonic generator according to claim 1, wherein
the jutting out portion is formed such that an installation portion that is a different member from a waveguide main body constituting the first shaft portion and the second shaft portion is held on an outer circumferential surface of the waveguide main body.

5. The ultrasonic generator according to claim 4, wherein
the installation portion includes an extension portion covering a part of the outer circumferential surface of the waveguide main body with a clearance interposed between the extension portion and the outer circumferential surface of the waveguide main body.

6. The ultrasonic generator according to claim 4, wherein
the installation portion is in contact with a part of the outer circumferential surface of the waveguide main body in a circumferential direction.

7. The ultrasonic generator according to claim 1- or 2, wherein
the first shaft portion, the second shaft portion, and the jutting out portion are formed as one member.

8. An ultrasonic generator comprising:
an ultrasonic wave generation source that generates an ultrasonic wave;
an ultrasonic wave converging portion that converges the ultrasonic wave generated from the ultrasonic wave generation source; and
a waveguide that transmits the ultrasonic wave converged by the ultrasonic wave converging portion,
the ultrasonic wave converging portion including
a first reflecting surface that reflects the ultrasonic wave generated at the ultrasonic wave generation source, and
a second reflecting surface that reflects the ultrasonic wave reflected by the first reflecting surface,
the first reflecting surface and the second reflecting surface being arranged such that the ultrasonic wave reflected by the second reflecting surface as a plane wave is introduced into the waveguide, wherein
the waveguide includes a shaft portion extending from the ultrasonic wave converging portion to one side in a predetermined direction, and
the ultrasonic generator further includes a cover covering an outer circumference of the shaft portion.

9. The ultrasonic generator according to claim 8, wherein
the cover is disposed around the shaft portion with a clearance interposed between the cover and the shaft portion.

10. The ultrasonic generator according to claim 8, wherein
the cover includes a first cover covering the outer circumference of the shaft portion and a second cover covering an outer circumference of the first cover, and
a value of an acoustic impedance of the first cover is more than or less than both values of an acoustic impedance of the shaft portion and an acoustic impedance of the second cover.

11. The ultrasonic generator according to claim 8, wherein
the cover is in contact with the shaft portion, and
a wave propagation velocity in the shaft portion is slower than a wave propagation velocity in the cover.

12. The ultrasonic generator according to claim 11, wherein
the wave propagation velocity in the cover is in a range of 1.3 to 1.7 times the wave propagation velocity in the shaft portion.
